(19) United States
(12) Patent Application Publication
(10) Pub. No.: US 2026/0084430 A1
(43) Pub. Date: Mar. 26, 2026

(54) INK CONTAINER, METHOD FOR MANUFACTURING INK CONTAINER CONTAINING INK, AND METHOD FOR INJECTING INK INTO INK CONTAINER

(71) Applicant: CANON KABUSHIKI KAISHA, Tokyo (JP)

(72) Inventor: HIROSHI INOMATA, Kanagawa (JP)

(21) Appl. No.: 19/328,658

(22) Filed: Sep. 15, 2025

(30) Foreign Application Priority Data
Sep. 24, 2024 (JP) 2024-164859

(51) Int. Cl. B41J 2/175

(52) U.S. Cl. CPC B41J 2/17559; B41J 2/17506; B41J 2/17513; B41J 2/1754; B41J 2/17596; B41J 2002/17516

(57) ABSTRACT

A method for manufacturing an ink container containing ink includes forming an opening portion in a surface of an ink container by inserting a needle into the ink container, which includes a flexible ink storage portion configured to store ink therein, and a structure provided inside the ink storage portion, injecting ink into the ink storage portion through the opening portion, and sealing the opening portion, wherein a position at which the opening portion is formed in the ink storage portion is in a vicinity of a region of the ink storage portion in which the structure is internally provided, when the ink storage portion is viewed from a direction in which the needle is inserted.

### BACKGROUND

### Field of the Technology

The present disclosure relates to an ink container, a method for manufacturing an ink container containing ink, and a method for injecting ink into an ink container.

### Description of the Related Art

In an inkjet recording apparatus, an inkjet recording head is mounted on a carriage, and the inkjet recording apparatus records images, characters, and the like on a recording medium by discharging ink from a discharge element substrate included in the ink jet recording head. The ink supplied to the inkjet recording head is supplied from an ink container attachable to and detachable from the inkjet recording apparatus. As such an ink container, there is known an ink container including a flexible ink storage portion for storing ink therein, and a structure that can be provided inside the ink storage portion. In general, the ink container with such a configuration is removed from the inkjet recording apparatus and replaced with a new one when the remaining amount of ink stored becomes less than a predetermined lower limit amount. Conventionally, the used ink containers removed from the inkjet recording apparatus have sometimes been simply discarded even though the ink storage portion and the structure remain in a usable condition. Such a situation is undesirable for realizing a decarbonized and circular society, which has been increasingly advocated in recent years.

As a reuse method of the ink container, Japanese Patent Laid-open No. 2019-198990 describes a configuration in which an opening portion for injecting ink therethrough is formed by cutting off the end region of an ink storage bag after the ink has been depleted, and the opening portion is heat sealed to close the opening portion after injecting ink through the opening portion. Further, Japanese Patent Laid-open No. 2019-198990 describes a configuration in which an opening portion for injecting ink therethrough is formed by inserting a needle into the end portion of the ink storage bag after the ink has been depleted, and the opening portion is sealed with a seal member after injecting ink through the opening portion. Among these configurations, the reuse method using a needle is advantageous, as it allows the ink container to be reused easily without the need to cut off or heat seal the end region.

However, in the method for reusing the ink container using a needle as described in Japanese Patent Laid-open No. 2019-198990, since the needle is inserted into the end portion of the ink storage bag, it is difficult to form the opening portion for injecting ink therethrough in the ink storage bag. This is because the inner surfaces of the ink storage bag at the end portion adhere closely each other after the ink has been depleted. As a result, there is a concern that the needle may penetrate both the front and back surfaces of the ink storage bag, or the takt time in the reuse process of the ink container may increase, thereby hindering the promotion of the reuse of the ink container.

### SUMMARY

In view of the above-described issues, the present disclosure is directed to an ink container that allows easy manufacturing and ink injection, a method for manufacturing the ink container, and an ink injection method that facilitates ink injection into the ink container.

According to some embodiments of the present disclosure, a method for manufacturing an ink container containing ink includes forming an opening portion in a surface of an ink container by inserting a needle into the ink container, which includes a flexible ink storage portion configured to store ink therein, and a structure provided inside the ink storage portion, injecting ink into the ink storage portion through the opening portion, and sealing the opening portion, wherein a position at which the opening portion is formed in the ink storage portion is in a vicinity of a region of the ink storage portion in which the structure is provided internally, when the ink storage portion is viewed from a direction in which the needle is inserted.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view of an inkjet recording apparatus.

FIG. 2A is a perspective view of an ink container, FIG. 2B is a side view of the ink container, and FIG. 2C is a top view of the ink container.

FIG. 3 is a perspective view of a structure.

FIG. 4A is an external view of an ink outlet portion, FIG. 4B is an external view of a first component, and FIG. 4C is an external view of a second component.

FIG. 5 is a cross-section view illustrating a connection between the inkjet recording apparatus and the ink container.

FIG. 6 is a flowchart illustrating an ink container manufacturing flow.

FIG. 7A is a side view of the ink container, FIG. 7B is an enlarged view illustrating a vicinity of an “A” portion of the ink container, FIG. 7C is a schematic view illustrating a process for forming an opening portion, and FIG. 7D is a top view of the ink container with the opening portion covered by a seal member.

FIG. 8 is a perspective view of a structure.

FIG. 9 is a top view of the structure.

FIG. 10 is a side view of an ink container in a mounted state.

FIG. 11 is a schematic front view of an ink introduction portion.

FIG. 12 is a schematic perspective view of the structure.

FIG. 13 is a schematic perspective view of the structure.

FIG. 14 is an enlarged view illustrating a vicinity of the structure of the ink container after the ink is depleted.

FIG. 15 is a schematic view illustrating processes of forming an opening portion.

FIG. 16 is a top view of a structure.

### DESCRIPTION OF THE EMBODIMENTS

### First Embodiment

Hereinbelow, various exemplary embodiments, features, and aspects of the present disclosure will be described with reference to the attached drawings. Note that the embodiments described below are not intended to limit the scope of the present disclosure, and not all the combinations of the features described in the embodiments are necessarily essential to the solutions provided by the present disclosure. In addition, the same reference numbers are assigned to identical components.

### <Inkjet Recording Apparatus>

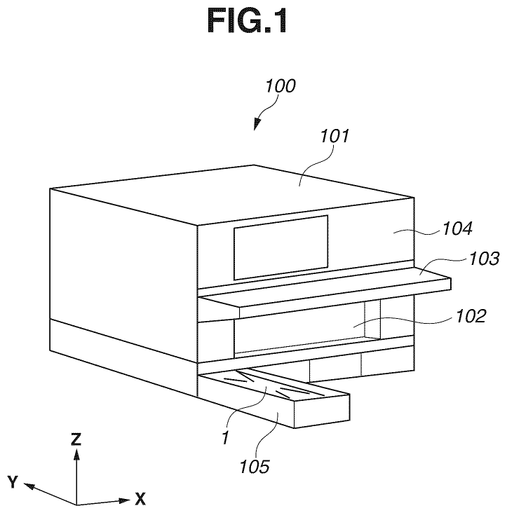

FIG. 1 is a perspective view of an inkjet recording apparatus 100 on which an ink container 1 according to a first embodiment is mounted. The inkjet recording apparatus 100 includes a case 101, a recording medium storage portion 102, a recording medium discharge portion 103, an operation panel 104, and a housing 105. The case 101 includes an inkjet recording head (not illustrated) for discharging ink, and a carriage (not illustrated) on which the inkjet recording head is mounted. The recording medium storage portion 102 can store a plurality of recording media. A recording medium is conveyed from the recording medium storage portion 102, and images and/or texts are recorded on the conveyed recording medium by discharging ink onto the conveyed recording medium from the inkjet recording head. The recording medium on which the recording process has been completed is discharged from the recording medium discharge portion 103, and a user can check the result. The operation panel 104 is a panel for a user to operate the inkjet recording apparatus 100. The housing 105 is a frame for inserting the ink container 1 according to the present disclosure into the apparatus. The number of the housings 105 to be provided can be changed depending on the number of kinds of inks that are discharged from the inkjet recording head. The ink in the ink container 1 is suctioned as desired by a suction pump mounted on the inkjet recording apparatus 100, and as the ink is supplied to the inkjet recording apparatus 100, the amount of the ink in the ink container 1 decreases.

Here, the dimensions used in the present specification will be described. An X direction refers to a width direction of the ink container 1, a Y direction refers to a direction in which the ink container 1 is moved forward and backward relative to the inkjet recording apparatus 100, and a Z direction refers to a direction perpendicular to the X direction and the Y direction and represents a thickness direction of the ink container 1.

### <Ink Container>

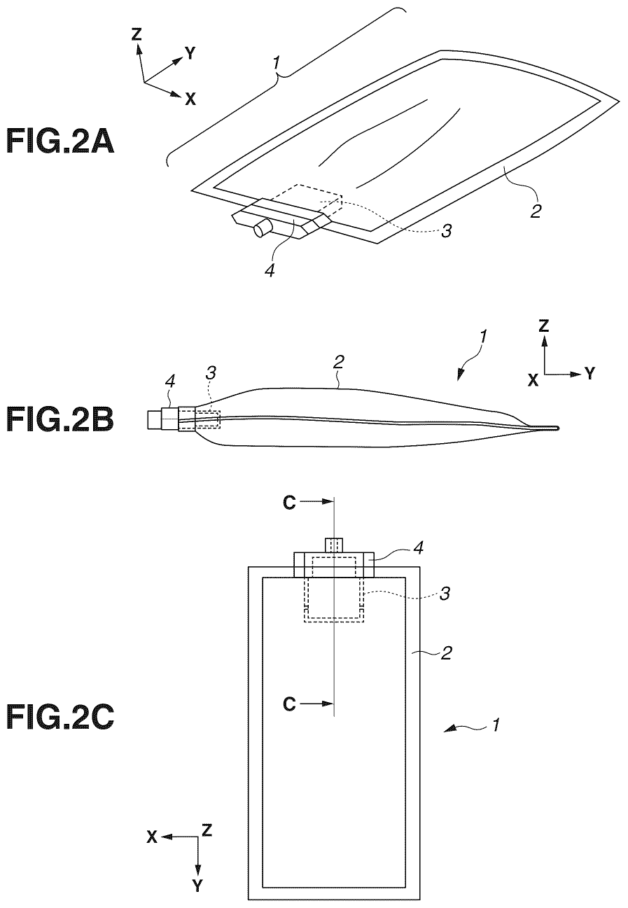

Next, with reference to FIGS. 2A, 2B, and 2C, details of the ink container 1 according to the present embodiment will be described. FIG. 2A is a perspective view of the ink container 1, FIG. 2B is a side view of the ink container 1 viewed from the X direction, and FIG. 2C is a top view of the ink container 1 viewed from the Z direction. The ink container 1 according to the present embodiment includes an ink storage bag 2 serving as an ink storage portion, and a structure 3, and an ink outlet portion 4.

The ink storage bag 2 is a bag that is flexible and can store ink therein. The ink storage bag 2 has a first surface and a second surface facing the first surface. The ink storage bag 2 may be a pillow type bag formed by placing two rectangular films in an overlapped manner and joining the peripheral edge portions thereof by heat sealing or the like, a gusset type bag with gussets formed on both ends thereof in the X direction, or a bag formed into a tubular shape by heat sealing a single film. Since the ink storage bag 2 stores ink therein, the ink storage bag 2 may have gas barrier properties to suppress ink evaporation, as well as abrasion resistance to prevent damage to the ink storage bag 2. Thus, the ink storage bag 2 can be formed by laminating a plurality of layers made of polyethylene terephthalate (PET), aluminum foil, nylon, polypropylene, and the like. In addition, in the present embodiment, the ink storage bag 2 is described as an example of the ink storage portion, but the ink storage portion is not limited to a bag, as long as it is a member to store ink.

The ink outlet portion 4 is a member for discharging the ink stored in the ink storage bag 2 to the outside. The ink outlet portion 4 can be provided with a check valve (not illustrated) for allowing the outflow of ink to the outside from the inside of the ink storage bag 2, and restricting the inflow of ink into the inner space of the ink storage bag 2 from the outside. In this way, it is possible to suppress the entry of ink, dust or the like into the ink storage bag 2 from the outside while allowing the outflow of the ink from the inside of the ink storage bag 2 to the outside. On the other hand, in a case where the check valve is provided in the ink outlet portion 4, it is difficult to inject ink through the ink outlet portion 4 into the ink storage bag 2. Thus, the ink container manufacturing method and the ink injection method according to the embodiments described below can be used for the ink container 1 with a check valve provided in the ink outlet portion 4.

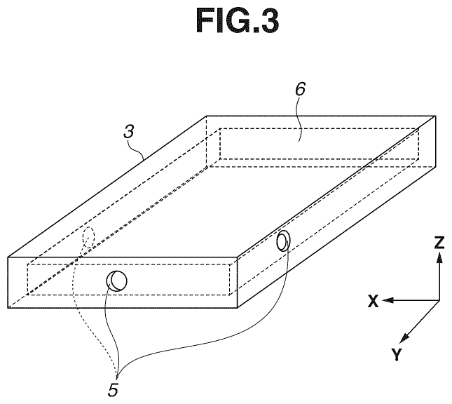

As illustrated in FIGS. 2A, 2B, and 2C, the structure 3 according to the present embodiment is a member at least a part of which is provided inside the ink storage bag 2, and extends from the ink outlet portion 4 toward the inner space of the ink storage bag 2. An enlarged view of the structure 3 is illustrated in FIG. 3. The structure 3 according to the present embodiment has a quadrangular prism shape. The material of the structure 3 is not specifically limited, but polyester or polypropylene can be used. A connection hole 6 is formed in the structure 3 on the side (Y direction) that is connected to the ink outlet portion 4, two communication holes 5 are formed in the respective sides in the X direction of the structure 3, and one communication hole 5 is formed in the opposite side of the ink outlet portion 4. Then, the inner space of the ink storage bag 2 and the ink outlet portion 4 communicate with each other via the structure 3. Since the communication hole 5 is formed on the surface of the structure 3 in the Y direction, and the two communication holes 5 are formed on the side surfaces of the structure 3 in the X direction, the liquid in the inner space of the ink storage bag 2 can be taken in evenly without bias. The ink taken into the structure 3 through the communication holes 5 is supplied to the ink outlet portion 4 via the connection hole 6. In addition, the shapes and the numbers of connection holes 6 and communication holes 5 are not limited thereto.

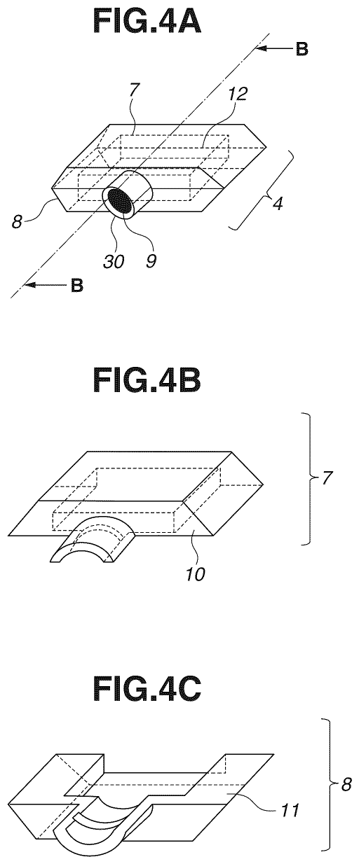

Next, details of the ink outlet portion 4 will be described. FIGS. 4A, 4B, and 4C are enlarged views of the ink outlet portion 4.

The ink outlet portion 4 illustrated in FIG. 4A is formed by assembling a first component 7 illustrated in FIG. 4B, a second component 8 illustrated in FIG. 4C, and an elastic member 9 made of elastomer such as rubber as a material. The first component 7 and the second component 8 are assembled by heat sealing or bonding them in a state where the clastic member 9 is sandwiched between a first surface 10 of the first component 7 and a second surface 11 of the second component 8. A connection hole 12 and an outlet port 30 are formed in the ink outlet portion 4 by assembling the first component 7 and the second component 8. The ink can be supplied from the structure 3 to the ink outlet portion 4 by joining the structure 3 and the ink outlet portion 4 to allow the connection hole 6 of the structure 3 and the connection hole 12 of the ink outlet portion 4 to communicate with each other. In addition, the joining method of the structure 3 and the ink outlet portion 4 is not specifically limited, but the structure 3 and the ink outlet portion 4 can be bonded using adhesive or heat sealed.

Further, the ink outlet portion 4 and the ink storage bag 2 are also joined together. The joining method of the ink outlet portion 4 and the ink storage bag 2 is also not specifically limited, heat sealing and bonding can be used. In a case of heat sealing them, they can be joined by heating them from the outside in a state where the ink storage bag 2 is placed on the ink outlet portion 4 in an overlapped manner, melting a heat-sealing layer of the ink storage bag 2 and the resin of the ink outlet portion 4, and then cooling them. In addition, the type of the adhesive used in a case of bonding them is not specifically limited.

### <Connection of Ink Container and Inkjet Recording Apparatus>

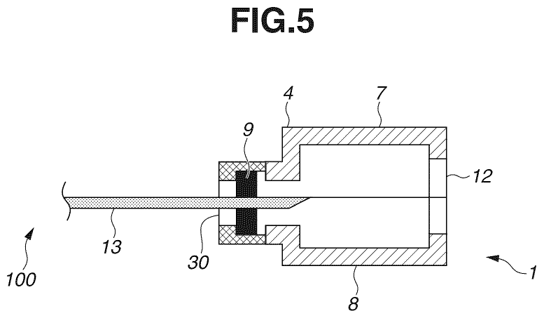

Next, the connection of the ink container 1 and the inkjet recording apparatus 100 will be described. FIG. 5 is a cross-sectional view illustrating the vicinity of the ink outlet portion 4 in a state where the ink container 1 and the inkjet recording apparatus 100 are connected, as viewed from the Y direction. In FIG. 5, portions other than the ink outlet portion 4 of the ink container 1 and portions other than a needle 13 of the inkjet recording apparatus 100 are not illustrated. The inkjet recording apparatus 100 has the hollow needle 13 for suctioning ink from the ink container 1, and the needle 13 is inserted into the outlet port 30 of the ink outlet portion 4. The ink flows through the hollow portion of the needle 13 from the ink container 1 when a suction pump mounted on the inkjet recording apparatus 100 suctions the ink in this state, and the ink is supplied to the inkjet recording apparatus 100.

<Manufacturing Method of Ink Container (Method for Injecting Ink into Ink Container)>

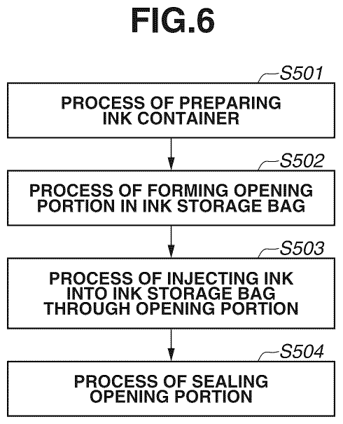

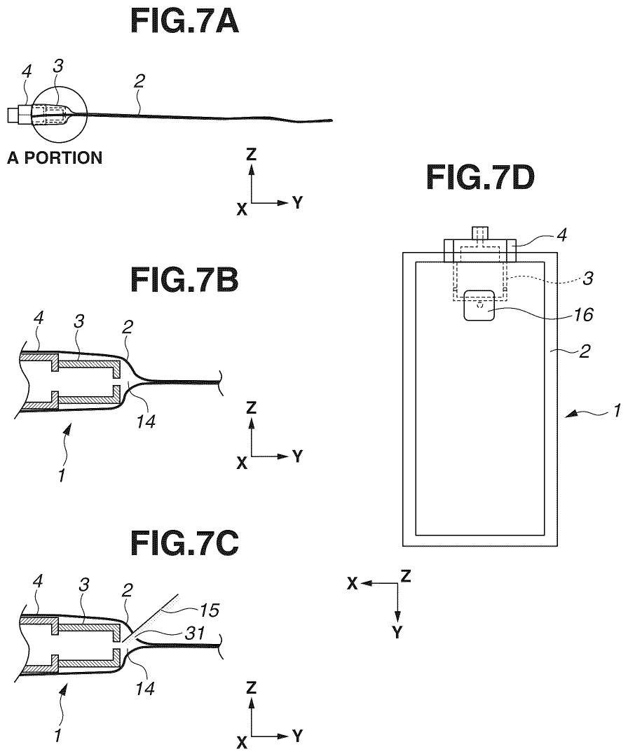

Next, a manufacturing method for the ink container 1 (method for injecting ink into an ink container) according to the present embodiment will be described. FIG. 6 illustrates a manufacturing flow (ink injection flow) for the ink container 1 according to the present embodiment. Each process will be described with reference to FIGS. 6 and 7A to 7D.

In step S501, the ink container 1 is prepared. FIG. 7A illustrates the process of preparing the ink container 1 (step S501), and is a cross-sectional view of the ink container 1 viewed from the X direction. As illustrated in FIG. 7A, when the ink stored in the ink storage bag 2 is depleted, the inner volume of the ink storage bag 2 decreases compared to when the ink is stored therein. In a case where the structure 3 is not provided in the inner space of the ink storage bag 2, the ink storage bag 2 can freely change its shape, and the first and second surfaces of the ink storage bag 2 can come into close contact each other. On the other hand, according to the present embodiment, the structure 3 is provided inside the ink storage bag 2, as illustrated in FIG. 7B (corresponding to C-C section in FIG. 2C), which is an enlarged view of an “A” portion in FIG. 7A. Thus, in a case where the stiffness of the surface of the ink storage bag 2 in the vicinity of the structure 3 is high in response to the suction force exerted by the inkjet recording apparatus 100 to draw the ink from the ink container 1, a region 14 is formed near the structure 3 where the first and second surfaces of the ink storage bag 2 do not come into contact with each other.

In addition, the ink storage bag 2 used in the present embodiment is laminated by aluminum foil as an anti-evaporation layer, and the stiffness thereof is higher than that of an ink storage bag without the aluminum foil lamination. Thus, the ink storage bag 2 does not easily deform along the shape of the structure 3, and the region 14 tends to be readily formed in the vicinity of the structure 3. In the present embodiment, the vicinity of the structure 3 refers to an area within 1 centimeter (cm) around the structure 3.

Next, in a process in step S502, an opening portion 31 is formed in the ink storage bag 2. At this time, as illustrated in FIG. 7C, a needle 15 is inserted into the surface of the ink storage bag 2 in the vicinity of the structure 3 to form the opening portion 31. In the vicinity of the structure 3, the region 14 is formed in which the first and second surfaces of the ink storage bag 2 are not in close contact with each other. Thus, when the ink storage bag 2 is viewed from the direction in which the needle 15 is inserted, inserting the needle 15 into the vicinity of the region of the ink storage portion in which the structure 3 is provided internally is equivalent to inserting the needle 15 into the ink storage bag 2 targeting the region 14. In a case where the needle 15 is inserted into the ink storage bag 2 targeting the region 14, since the first and second surfaces are not in close contact with each other, the opening portion 31 can be easily formed. In other words, it is possible to reduce the risk of the needle 15 penetrating both the front and back surfaces of the ink storage bag 2, or the risk of increasing the takt time in manufacturing the ink container 1.

Further, a position indication portion (not illustrated) indicating a position of the region where the first and second surfaces are not in close contact with each other can be provided at a position of the ink storage bag 2 overlapping the region 14 when the ink storage bag 2 is viewed from a thickness direction of the ink storage bag 2 (Z direction). The provision of the position indication portion allows, when the opening portion 31 is formed in the ink storage bag 2, the needle 15 to be accurately inserted targeting the region 14. The position indication portion can be printed on the ink storage bag 2, but the configuration is not limited thereto.

Further, the angle at which the needle 15 is inserted into the ink storage bag 2 can be an angle that allows the needle 15 to be easily inserted into the ink storage bag 2. For example, the needle 15 can be inserted so that the leading end of the needle 15 becomes approximately perpendicular to the surface of the ink storage bag 2. Further, when the needle 15 is inserted into the ink storage bag 2, the leading end of the needle 15 can be inserted so that the leading end thereof comes into contact with the structure 3. In this way, it is possible to further reduce the risk of the needle 15 penetrating both the front and back surfaces of the ink storage bag 2 while allowing the opening portion 31 to be easily formed by targeting at the region 14.

Next, in a process in step S503, ink is injected into the ink storage bag 2 through the opening portion 31.

In the process in step S503, the ink can be injected through the needle 15 that has been used to form the opening portion 31 in the ink storage bag 2, but the ink may be injected using a different needle. In a case where the ink is injected using the needle 15 that has been used to form the opening portion 31 in the ink storage bag 2, the ink is injected in the state illustrated in FIG. 7C.

The ink injected into the inner space of the ink storage bag 2 will flow out thorough the opening portion 31 if the opening portion 31 is left open. Thus, in a process in step S504, the opening portion 31 formed in the ink storage bag 2 is sealed. FIG. 7D is an external appearance view illustrating the ink container 1 with the opening portion 31 sealed by a seal member 16, when viewed from the Z direction. The seal member 16 having an adhesive layer on its surface that comes into contact with the ink storage bag 2 and a base layer having the same material as that of the ink storage bag 2 can be used. By doing so, the seal member 16 can more easily seal the opening portion 31, and since the properties of the seal member 16 are similar to those of the ink storage bag 2, it is possible to reduce the risk of the seal member 16 peeling off due to the flexing of the ink storage bag 2.

As described above, according to the present embodiment, it is possible to provide a method for manufacturing ink containers (ink injection method) that enables easy production (ink injection). Accordingly, since it is possible to promote the reuse of ink containers, the number of ink containers that are discarded can be reduced. As a result, the technique described in the present specification can contribute to the realization of a sustainable society, such as a decarbonized and circular society.

### Modification Example of Seal Member

Next, a modification example of the seal member 16 will be described.

A member that is stiffer than the ink storage bag 2 can be employed as the seal member 16. Since the stiffness of the seal member 16 is high, wrinkles are less likely to be generated on the seal member 16 when the seal member 16 is attached to the ink storage bag 2. Thus, it is easy to handle the seal member 16, and the opening portion 31 can be stably sealed. The method for generating a difference in stiffness between the ink storage bag 2 and the seal member 16 is not specifically limited, and the stiffness difference can be generated, for example, by using an alumina vapor-deposited layer for the ink storage bag 2 and providing an aluminum foil layer on the seal member 16. In addition, for example, for the ink storage bag 2, a film made by laminating a layer of alumina vapor-deposited onto polyethylene (PE) between a nylon layer and a polypropylene layer can be used, and for the seal member 16, a film having the same layer configuration and made by laminating two layers of alumina vapor-deposited onto PE can be used.

Further, as the seal member 16, a member having stiffness lower than the ink storage bag 2 can also be employed. Due to the low stiffness of the seal member 16 is, when the ink storage bag 2 is reused a plurality of times, it is possible to easily attach a plurality of the seal members 16 at the same position in an overlapped manner. Further, when the ink storage bag 2 deflates as the ink stored in the ink storage bag 2 is consumed, the deflation of the ink storage bag 2 is not affected due to the low stiffness of the seal member 16. For example, for the seal member 16, a film made by laminating a layer of alumina vapor-deposited onto PE between a nylon layer and a polypropylene layer can be used, and for the ink storage bag 2, a film having the same layer configuration and made by laminating two layers of alumina vapor-deposited onto PE can be used.

Further, the seal member 16 can include an ink information indication portion for indicating information about ink stored in the ink storage bag 2. As a result, the seal member 16 can be integrated with the member that displays the information about the ink stored in the ink storage bag 2, whereby the number of materials used can be reduced. In other words, the number of discarded materials can be reduced, which is advantageous from the perspective of the environmental protection.

### <Configuration of Seal Member Containing Elastomer>

Further, a seal member containing elastomer may be used as the seal member 16. In this case, before the process of forming the opening portion 31 in the ink storage bag 2 in step S502, a process of attaching the seal member 16 in the vicinity of the region where the structure 3 is internally provided in the ink storage bag 2. Then, in the process of forming the opening portion 31, the opening portion 31 is formed in the ink storage bag 2, and a second opening portion (not illustrated) is formed in the seal member 16, by inserting the needle 15 into the ink storage bag 2 via the seal member 16. At this time, in the process of injecting ink in step S503, the ink is injected through the needle 15 without pulling out the needle 15 inserted in the ink storage bag 2 in the process of forming the opening portions in step S502. Then, when the needle 15 is pulled out from the ink storage bag 2, the second opening portion, which has once expanded, is closed by the elastic force of the elastomer. In other words, the process of sealing the opening portion 31 is performed by the second opening portion being closed by the elastic force of the seal member 16. Thus, in the case where the seal member 16 contains elastomer, ink can be injected into the ink storage bag 2 a plurality of times via the elastomer. Further, when the needle 15 is pulled out, the second opening portion formed in the seal member 16 is closed by the elastic force before the ink leaks out from the ink storage bag 2, thereby making it possible to reduce the risk of the ink leaking out from the ink storage bag 2.

Further, in the case where the seal member 16 contains elastomer, the seal member 16 may be attached in advance at the start of use of the ink storage bag 2, or may be attached from the second and subsequent uses during reuse. By attaching the seal member 16 in advance, it is possible to reduce the risk of a sealing failure due to the generation of wrinkles between the seal member 16 and the ink storage bag 2 when the seal member 16 is attached to the ink storage bag 2, compared to the case of attaching the seal member 16 to the ink storage bag 2 in a state where the ink is depleted.

### Second Embodiment

Next, the ink container 1 according to a second embodiment will be described. A structure 23 according to the second embodiment is mainly different from the structure 3 according to the first embodiment. In the following description, portions different from those of the first embodiment are mainly described, and the descriptions of portions similar to those of the first embodiment are omitted.

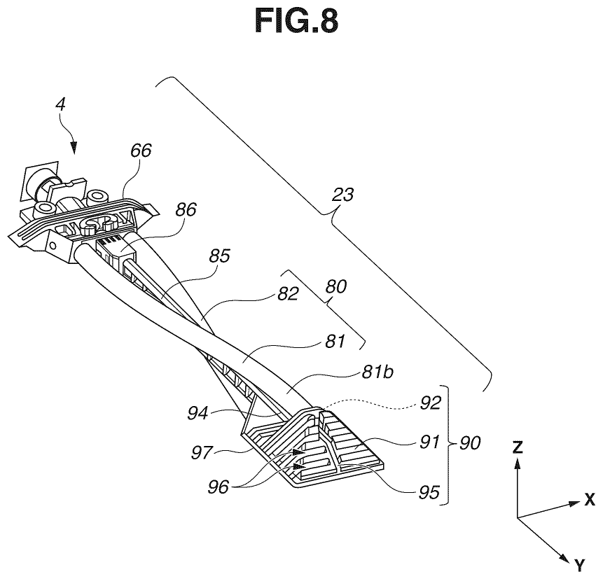

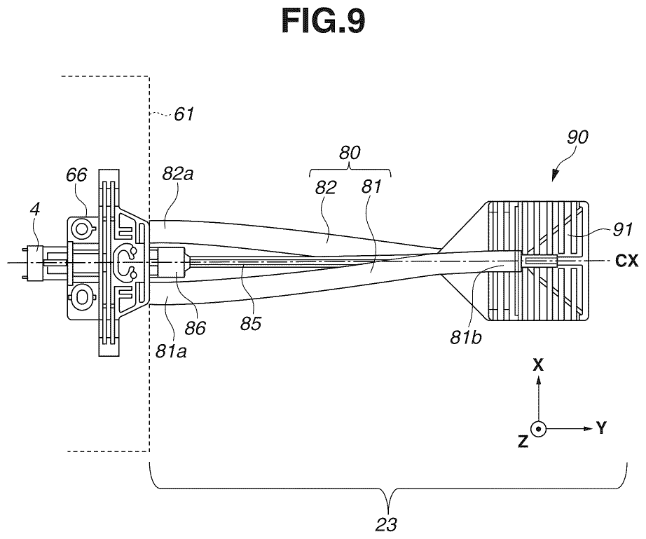

FIG. 8 is a perspective view of the structure 23 according to the present embodiment, and FIG. 9 is a top view of the structure 23 viewed from the Z direction. The illustration of the ink storage bag 2 is omitted in FIGS. 8 and 9. The structure 23 is formed, for example, from synthetic resins, such as polyethylene and polypropylene. The structure 23 includes ink supply pipes 80 for supplying ink to the ink outlet portion 4, an ink introduction portion 90 with grooves formed therein for introducing ink into the ink supply pipes 80, and a coupling member 85 for coupling the ink introduction portion 90 and the ink outlet portion 4 together.

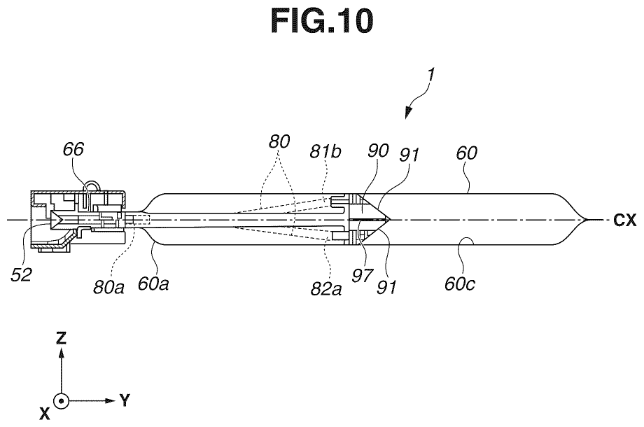

Next, with reference to FIG. 10, the orientation of the ink container 1 when mounted on the inkjet recording apparatus 100 will be described. In the orientation in which the ink container 1 is mounted on the inkjet recording apparatus 100, at least one of the lowermost part and the uppermost part of the ink introduction portion 90 in the Z direction comes into contact with the inner surface of the ink storage bag 2. In the present embodiment, as illustrated in FIG. 10, both of the lowermost part and the uppermost part of the ink introduction portion 90 are in contact with the inner surface of the ink storage bag 2. Hereinbelow, the orientation of the ink container 1 in the state where the ink container 1 is mounted on the inkjet recording apparatus 100 is referred to as a “mounted orientation”.

The ink introduction portion 90 has a portion that is located on the Y direction side relative to the ink supply pipes 80.

Further, the ink introduction portion 90 is provided at a position where it intersects with a YZ plane passing through a center axis CX of the ink outlet portion 4. The YZ plane is a plane including the Y and Z directions. The ink introduction portion 90 has inclined surfaces 91 each of which inclines in the Y direction such that the dimension thereof increases along the Z direction. In the present embodiment, the ink introduction portion 90 has the respective inclined surfaces 91 on the Z direction side relative to the center axis CX. In addition, in the present embodiment, the term “surface” refers to not only a surface constituted solely by a flat surface, but also a surface with a groove or a concave portion formed therein, a surface with a protrusion or a convex portion formed therein, or a virtual surface surrounded by a frame. In other words, as long as the “surface” can be recognized as a whole, the surface may have a concave portion and a convex portion, or a through-hole within its defined area. In the present embodiment, in the mounted orientation, the center between the lowermost part and the uppermost part of the ink introduction portion 90 in its height direction (Z direction) is the same height as the center axis CX of the ink outlet portion 4 are the same.

In the mounted orientation, the ink supply pipes 80 extend from the ink outlet portion 4 toward the inner space of the ink storage bag 2 in the horizontal direction. Further, in the present embodiment, the ink introduction portion 90 is fixed to the ink outlet portion 4 by the coupling member 85. In the present embodiment, the coupling member 85 is integrally connected to the ink introduction portion 90.

The ink supply pipes 80 includes a first flow path portion 81 and a second flow path portion 82. In the present embodiment, the ink container 1 includes two flow path portions, but may include three or more flow path portions.

Further, in the present embodiment, the first flow path portion 81 and the second flow path portion 82 have the same length, but it is not limited to the configuration.

As illustrated in FIG. 9, the first flow path portion 81 includes a first base end portion 81a connected to the ink outlet portion 4, and a first leading end portion 81b introducing ink stored in the inner space of the ink storage bag 2 into the first flow path portion 81. The second flow path portion 82 includes a second base end portion 82a connected to the ink outlet portion 4, and a second leading end potion 82b introducing the ink stored in the inner space of the ink storage bag 2 into the second flow path portion 82. As illustrated in FIG. 10, in the mounted orientation, the first leading end portion 81b is located above the second leading end potion 82b in the Z direction.

The end portion in the Y direction of the coupling member 85 is provided with a latch portion 86, which is held and fixed by engaging with a claw portion provided on a Y direction-side surface. In addition, in a different embodiment, the ink introduction portion 90 may be arranged without being fixed to the ink outlet portion 4. For example, the ink introduction portion 90 may be fixed to the inner surface of the ink storage bag 2.

In addition, as illustrated in FIG. 9, the above-described latch portion 86 is arranged so as to be sandwiched between the first base end portion 81a of the first flow path portion 81 and the second base end portion 82a of the second flow path portion 82 in the horizontal direction.

As illustrated in FIGS. 9 and 10, in the mounted orientation, the first base end portion 81a of the first flow path portion 81 and the second base end portion 82a of the second flow path portion 82 are arranged side by side in the horizontal direction, and the first leading end portion 81b of the first flow path portion 81 and the second leading end potion 82b of the second flow path portion 82 are arranged side by side in the vertical direction. Thus, the liquid drawn in through the first flow path portion 81 and the second flow path portion 82 transitions from flowing side by side in the vertical direction to flowing side by side in the horizontal direction, after which it mixes within the ink outlet portion 4 and is subsequently guided from the ink storage bag 2 to the inkjet recording apparatus 100.

In addition, in a different embodiment, a configuration in which the first base end portion 81a and the second base end portion 82a are arranged side by side in the vertical direction, and the first leading end portion 81b and the second leading end potion 82b are arranged side by side in the horizontal direction can be employed. Further, a configuration in which the first base end portion 81a and the second base end portion 82a are arranged side by side in the vertical direction, and the first leading end portion 81b and the second leading end potion 82b are also arranged side by side in the vertical direction, and a configuration in which the first base end portion 81a and the second base end portion 82a are arranged side by side in the horizontal direction, and the first leading end portion 81b and the second leading end potion 82b are also arranged side by side in the horizontal direction can also be employed.

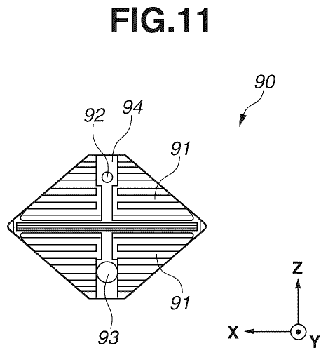

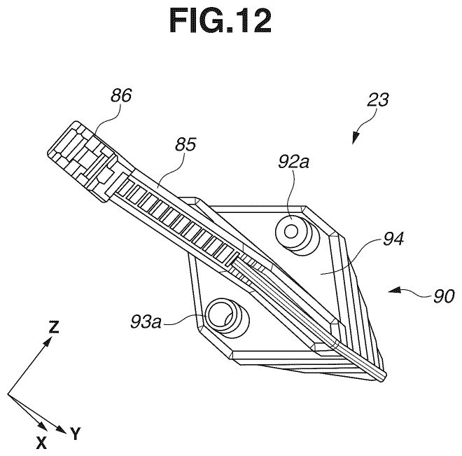

FIG. 11 is a schematic front view of the ink introduction portion 90. FIG. 12 is a schematic perspective view of the back side of the ink introduction portion 90. The ink introduction portion 90 includes a first introduction port 92 and a second introduction port 93. The first introduction port 92 is an opening for introducing the liquid in the upper side in the Z direction of the inner space of the ink storage bag 2 into the first flow path portion 81. The second introduction port 93 is an opening for introducing the liquid in the lower side in the Z direction of the inner space of the ink storage bag 2 into the second flow path portion 82.

As illustrated in FIG. 8, the ink introduction portion 90 includes a back side member 94 along an XZ plane at a position at which the dimension in the Z direction is largest. The back side member 94 has an approximately hexagonal shape with horizontal upper and bottom sides. The first introduction port 92 and the second introduction port 93 are provided in this back side member 94. In the present embodiment, the first introduction port 92 is smaller in internal diameter than the second introduction port 93.

In other words, the second introduction port 93 is larger in internal diameter than the first introduction port 92. Thus, the second introduction port 93, which is located lower than the first introduction port 92, tends to draw ink more easily from the inner space of the ink storage bag 2. In addition, as illustrated in FIG. 9, in the present embodiment, the ink introduction portion 90 has inclined surfaces not only in the Y direction but also in the X direction.

The first introduction port 92 and the second introduction port 93 are oriented toward the Y direction. Further, the first introduction port 92 and the second introduction port 93 are arranged at symmetry positions in the Z direction with respect to the center axis CX of the ink outlet portion 4, as illustrated in FIG. 10. The first introduction port 92 is arranged on the upper side of the center axis CX, and the second introduction port 93 is arranged on the lower side of the center axis CX.

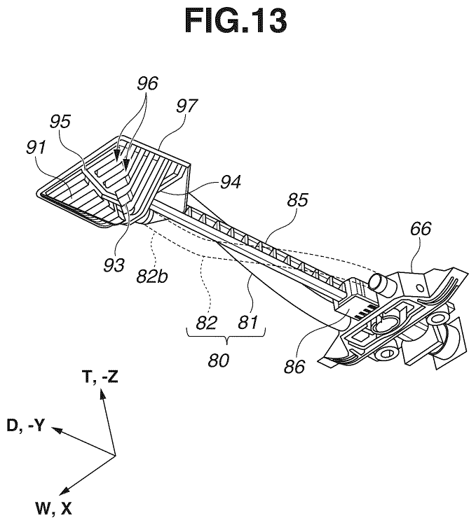

As illustrated in FIG. 8, the first leading end portion 81b of the first flow path portion 81 of the ink supply pipes 80 is connected to the first introduction port 92. FIGS. 12 and 13 are schematic perspective views of the structure 23. As illustrated in FIG. 12, a first connection pipe 92a having a cylindrical shape and communicating with the first introduction port 92 is provided in the surface of the back side member 94, and the first leading end portion 81b of the first flow path portion 81 is connected with the first introduction port 92 by inserting the first connection pipe 92a into the first leading end portion 81b of the first flow path portion 81. The second leading end potion 82b of the second flow path portion 82 is connected with the second introduction port 93. More specifically, the surface on the Y direction side of the back side member 94 is provided with a second connection pipe 93a having a cylindrical shape and communicating with the second introduction port 93, and the second connection pipe 93a is inserted into the second leading end potion 82b of the second flow path portion 82, so that the second leading end potion 82b of the second flow path portion 82 is connected to the second introduction port 93. In the present embodiment, the second connection pipe 93a and the first connection pipe 92a are the same in length along the Y direction.

As illustrated in FIGS. 8 and 13, the ink introduction portion 90 includes a first flow path 95 and second flow paths 96 each having a groove shape. The first flow path 95 is a flow path for allowing liquid to flow to the first introduction port 92 and the second introduction port 93. The second flow paths 96 are flow paths for allowing liquid to flow in a direction intersecting with the Y direction. In the present embodiment, a plurality of the second flow paths 96 is formed. Each of the second flow paths 96 is formed by creating a groove extending vertically along the X direction from the inclined surface 91 of the ink introduction portion 90. In addition, the second flow paths 96 may be formed so as to allow the ink to flow in a direction intersecting with both of the X and Y directions. Further, the ink introduction portion 90 may be configured to have only either one of the first flow path 95 and the second flow paths 96.

In the present embodiment, the ink introduction portion 90 includes a plate-like partition member 97 arranged along an XY plane (horizontal plane). The partition member 97 is arranged at a position between the first leading end portion 81b and the second leading end potion 82b in the Z direction, i.e., between the first introduction port 92 and the second introduction port 93. In the present embodiment, the partition member 97 passes through the center axis CX of the ink outlet portion 4. In other words, in the present embodiment, the partition member 97 is horizontally arranged at the center of the inner space of the ink storage bag 2. It can be also said that the plurality of second flow paths 96 is formed by providing a plurality of ribs on the partition member 97. In addition, in a different embodiment, the partition member 97 may be omitted.

### Method for Manufacturing Ink Container (Ink Injection Method) in Second Embodiment

Next, a method for manufacturing an ink container (ink injection method) including the structure 23 according to the present embodiment will be described.

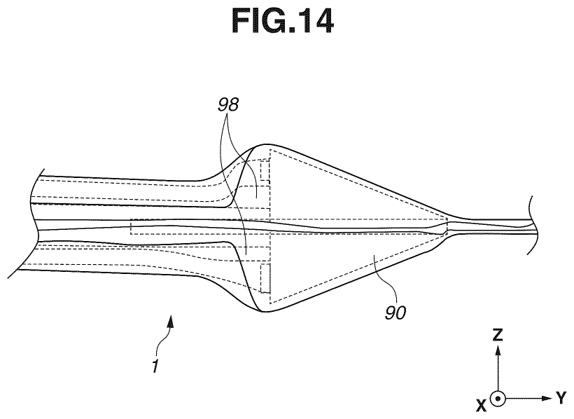

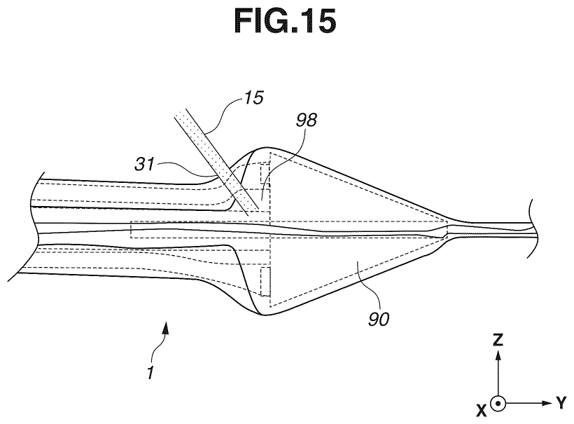

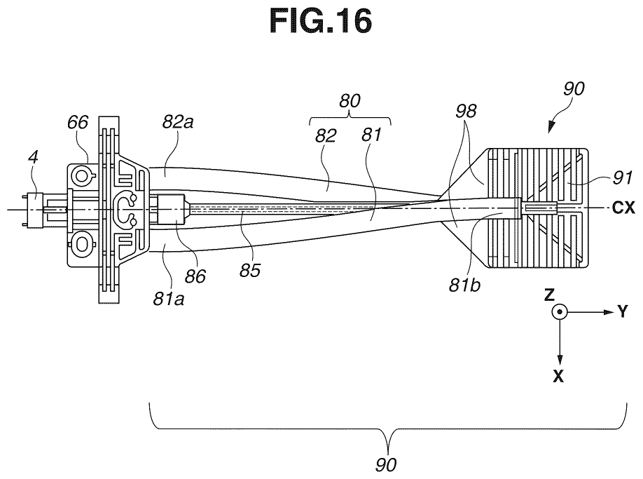

FIGS. 14 and 15 are enlarged views of the end side in the Y direction of the ink introduction portion 90 in the ink container 1 in a state where ink is depleted, when viewed in the X direction. Further, FIG. 16 is a view illustrating the ink introduction portion 90 viewed from the Z direction, and the positions of regions 98 described below are indicated in the FIG. 16.

In the ink introduction portion 90, a corner portion is present, which is formed by a protruding portion on the back side member 94 in the Z direction and a planar portion of the partition member 97. As illustrated in FIG. 14, when the ink in the ink storage bag 2 is depleted, the corner portion may appear where the ink storage bag 2 does not fully conform to the shape of the ink introduction portion 90 in response to ink suction by the inkjet recording apparatus 100. In other words, the regions 98, in which the first surface and the second surface are not in close contact with each other, are generated.

Similar to the process in step S502 according to the first embodiment, as illustrated in FIG. 15, the opening portion 31 is formed in the ink storage bag 2 by inserting the needle 15 in the region 98. In the region 98, similar to the first embodiment, the front and back surfaces of the ink storage bag 2 are not in close contact with each other, and it is easy to form the opening portion 31. In other words, it is possible to reduce the risk of the needle 15 penetrating both the front and back surfaces of the ink storage bag 2, or the risk of increasing the takt time in manufacturing the ink container 1. In addition, since the ink supply pipes 80 are arranged near the center in the X direction of the ink introduction portion 90, the needle 15 can be inserted at a position so as to prevent the positions of the ink supply pipes 80.

Next, similar to the process in step S503 according to the first embodiment, ink is injected into the ink storage bag 2 through the opening portion 31. Then, similar to the process in step S504 according to the first embodiment, the opening portion 31 is sealed. In this way, the ink container 1 can be manufactured (ink can be injected into the ink container 1).

As described above, according to the present embodiment, it is possible to provide a method for manufacturing ink containers (ink injection method) that allows for easy production (ink injection). Accordingly, since the reuse of ink containers can be promoted, which may lead to a reduction in the number of discarded ink containers. In other words, the technique described in the present specification can contribute to the realization of a sustainable society such as a decarbonized or circular society.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-164859, filed Sep. 24, 2024, which is hereby incorporated by reference herein in its entirety.

What is claimed is:

1. A method for manufacturing an ink container containing ink, the method comprising:
forming an opening portion in a surface of an ink container by inserting a needle into the ink container, the ink container including a flexible ink storage portion configured to store ink therein, and a structure provided inside the ink storage portion;
injecting ink into the ink storage portion through the opening portion; and
sealing the opening portion,
wherein a position at which the opening portion is formed in the ink storage portion is in a vicinity of a region of the ink storage portion in which the structure is provided internally, when the ink storage portion is viewed from a direction in which the needle is inserted.

2. The method for manufacturing an ink container containing ink according to claim 1,
wherein the ink container further includes an ink outlet portion configured to discharge the ink stored inside the ink storage portion to outside, and
wherein the structure extends from the ink outlet portion toward the ink storage portion.

3. The method for manufacturing an ink container containing ink according to claim 2, wherein the structure includes an ink supply pipe configured to supply ink to the ink outlet portion, an ink introduction portion with a groove formed therein to introduce ink to the ink supply pipe, and a coupling member configured to couple the ink introduction portion and the ink outlet portion.

4. The method for manufacturing an ink container containing ink according to claim 2, wherein the ink outlet portion is provided with a check valve configured to restrict ink from flowing into the ink storage portion from outside.

5. The method for manufacturing an ink container containing ink according to claim 1,
wherein the ink storage portion is a bag having a first surface and a second surface facing the first surface,
wherein a region in which the first surface and the second surface are not in close contact with each other is formed in a vicinity of the structure, and
wherein, in the forming of the opening portion, the opening portion is formed by inserting the needle into the ink storage portion targeting the region in which the first surface and the second surface are not in close contact with each other.

6. The method for manufacturing an ink container containing ink according to claim 5, wherein a position indication portion for indicating a position of the region in which the first surface and the second surface are not in close contact with each other is provided at a position on the ink storage portion that overlaps with the region in which the first surface and the second surface are not in close contact with each other, when the ink storage portion is viewed from the direction in which the needle is inserted.

7. The method for manufacturing an ink container containing ink according to claim 1, wherein the opening portion is formed at a position on the ink storage portion that overlaps with the structure, when the ink storage portion is viewed from the direction in which the needle is inserted.

8. The method for manufacturing an ink container containing ink according to claim 1, wherein, in the sealing of the opening portion, a seal member with stiffness higher than the ink storage portion is attached to the ink storage portion to seal the opening.

9. The method for manufacturing an ink container containing ink according to claim 8, wherein the seal member includes an ink information indication portion for indicating information about the ink stored in the ink storage portion.

10. The method for manufacturing an ink container containing ink according to claim 1, wherein, in the sealing of the opening portion, a seal member with stiffness lower than the ink storage portion is attached to the ink storage portion to seal the opening in the sealing.

11. The method for manufacturing an ink container containing ink according to claim 1, further comprising attaching a seal member, before the forming of the opening portion, to the vicinity of the region of the ink storage portion in which the structure is provided internally, when the ink storage portion is viewed from the direction in which the needle is inserted,
wherein the seal member contains elastomer,
wherein, in the forming of the opening portion, the opening portion is formed in the ink storage portion, and a second opening portion is formed in the seal member, by inserting the needle into the ink storage portion via the seal member,
wherein, in the injecting of the ink, the ink is injected into the ink storage portion through the needle via the opening portion, without pulling out the needle inserted into the ink storage portion in the forming of the opening portion, and
wherein, in the sealing of the opening portion, the second opening portion is closed by an elastic force of the seal member to seal the opening.

12. An ink container comprising:
an ink storage portion configured to be flexible and to store ink therein; and
a structure provided inside the ink storage portion,
wherein an opening portion is formed in a vicinity of a region of the ink storage portion in which the structure is provided internally, when the ink storage portion is viewed from a thickness direction of the ink storage portion, and
wherein the opening portion is sealed by a seal member.

13. The ink container according to claim 12, further comprising an ink outlet portion configured to discharge the ink stored inside the ink storage portion to outside,
wherein the structure includes an ink supply pipe configured to supply ink to the ink outlet portion, an ink introduction portion with a groove formed therein to introduce ink to the ink supply pipe, and a coupling member configured to couple the ink introduction portion and the ink outlet portion.

14. The ink container according to claim 13, wherein the outlet portion is provided with a check valve configured to restrict ink from flowing into the ink storage portion from outside.

15. The ink container according to claim 12,
wherein the ink storage portion is a bag having a first surface and a second surface facing the first surface, and
wherein the opening portion is formed at a position on the ink storage portion that overlaps with the structure, when the ink storage portion is viewed from the thickness direction of the ink storage portion.

16. The ink container according to claim 12,
wherein the ink storage portion is a bag having a first surface and a second surface facing the first surface,
wherein a region in which the first surface and the second surface are not in close contact with each other is formed in a vicinity of the structure, and
wherein a position indication portion indicating a position of the region in which the first surface and the second surface are not in close contact with each other is provided at a position on the ink storage portion that overlaps the region in which the first surface and the second surface of the ink storage portion are not in close contact with each other, when the ink storage portion is viewed from the thickness direction of the ink storage portion.

17. The ink container according to claim 12, wherein the seal member is higher in stiffness than the ink storage portion.

18. The ink container according to claim 12, wherein the seal member is lower in stiffness than the ink storage portion.

19. The ink container according to claim 12, wherein the seal member includes an ink information indication portion indicating information about the ink stored in the ink storage portion.

20. A method for injecting ink into an ink container, the method comprising:
forming an opening portion in a surface of an ink container by inserting a needle into the ink container, the ink container including a flexible ink storage portion configured to store ink therein, and a structure provided inside the ink storage portion;
injecting ink into the ink storage portion through the opening portion; and
sealing the opening portion,
wherein a position of the ink storage portion at which the opening portion is formed is in a vicinity of a region of the ink storage portion in which the structure is internally provided, when the ink storage portion is viewed from a direction in which the needle is inserted.
